(19) United States
(12) Patent Application Publication
(10) Pub. No.: US 2013/0175061 A1
(43) Pub. Date: Jul. 11, 2013

(54) HANDHELD AEROSOL FIRE EXTINGUISHING APPARATUS

(71) Applicants: Hongbao Guo, Xi'an (CN); Weipeng Zhang, Xi'an (CN); Chunjie Ma, Xi'an (CN); Chenggong Ma, Xi'an (CN); Zhiping Yin, Xi'an (CN)

(72) Inventors: Hongbao Guo, Xi'an (CN); Weipeng Zhang, Xi'an (CN); Chunjie Ma, Xi'an (CN); Chenggong Ma, Xi'an (CN); Zhiping Yin, Xi'an (CN)

(73) Assignee: SHAANXI J&R FIRE FIGHTING CO., LTD., Xi'an (CN)

(21) Appl. No.: 13/824,238

(22) PCT Filed: Sep. 7, 2011
(86) PCT No.: PCT/CN11/79421

§ 371 Date: Mar. 15, 2013

(30) Foreign Application Priority Data
Sep. 16, 2010 (CN) CN201020534622.X

(51) Int. Cl. A62C 13/22

(52) U.S. Cl. CPC A62C 13/22
USPC 169/71

(57) ABSTRACT

A hand-held aerosol fire suppression apparatus comprises an outer cylinder, inner cylinder components, a handle, and an activation device, wherein each outer cylinder is provided with at least three inner cylinder components. Compared with the prior art, the present invention has the following advantages: 1. the outer cylinder is provided with three or more inner cylinder components, so as to achieve a large ejecting area, a high fire suppression efficiency, and safety in use; 2. The members of the inner cylinder component are assembled together as one component, so as to achieve a convenient assembly and a high production efficiency.

### TECHNICAL FIELD

The present application belongs to the technical field of novel gas fire suppression, and relates to a hand-held hot aerosol fire suppression apparatus.

### BACKGROUND ART

The occurrence of fire usually causes large loss of human life and severe property damage. An appropriate firefighting apparatus is indispensable for putting out fire in its initial stage. Different occasions have different requirements on the firefighting apparatus. In our working and living environments in modern times, for limited spaces such as transportation vehicles, electronic apparatuses, home electric appliances, kitchens and so on, a hand-held fire suppression apparatus is convenient, fast and efficient, and can often get twice the result with half the effort as compared with other kinds of firefighting apparatuses.

Compared with conventional types of fire extinguishers such as a dry powder/foam/gas fire extinguisher, a hot aerosol fire extinguisher has the characteristics of a small volume, a low weight and high fire suppression efficiency. An important research direction for extending the application of the aerosol fire suppression apparatus is its miniaturization and portability. The Italian Firecom Company has developed a hand-held hot aerosol fire extinguisher, which does not have cooling and heat insulation parts, wherein after the medical is ignited, the hot aerosol directly spurts out, and the temperature at the jet orifice reaches 1200° C. or above with a flame having a length of 100 mm or above. If this fire extinguisher is not carefully used, the operator will be easily scalded. Further, this fire extinguisher uses a battery as an activation power supply, and the power of the battery will gradually decrease as the time goes by. The fire is a non-periodic accident, so it is impossible to determine whether the battery can start up the fire extinguisher normally after the fire extinguisher is left unused for a long time. In this case, the prior Chinese patent application (“HAND-HELD AEROSOL FIRE SUPPRESSION APPARATUS”, Application No. 200920033448.8) and the prior Chinese patent application (“NOVEL HAND-HELD AEROSOL FIRE SUPPRESSION APPARATUS”, Application No. 201020102303.1) filed by the applicant use a cooling device to solve the problem that the jet orifice of the fire extinguisher has a high temperature and will easily cause the operator to be scalded, and also use a piezoelectric activation device to solve the problem that it is impossible to determine whether the fire extinguisher can be started up normally after it is left unused for a long time.

A hand-held hot aerosol fire extinguisher product is not found either at home or abroad.

### DISCLOSURE OF THE INVENTION

The object of the present invention is to provide a hand-held aerosol fire extinguisher with a more reasonable device structure and a more convenient assembling method.

The following is the technical solution of the present invention.

The present invention provides a hand-held aerosol fire suppression apparatus, comprising an outer cylinder 19, inner cylinder components, and an activation device, wherein each outer cylinder 19 is provided with at least three inner cylinder components.

The present invention further provides a hand-held aerosol fire suppression apparatus, wherein the inner cylinder components are directly fixed to the outer cylinder 19.

The present invention further provides a hand-held aerosol fire suppression apparatus, wherein the inner cylinder component includes a spring 1, a heat insulation sleeve 2, a medical agent 11, an ignition head 3, a granular chemical coolant 4, a cellular chemical coolant 6, a trumpet-like jet pipe 7, a sealing ring 10, and an inner cylinder front cover 9.

The present invention further provides a hand-held aerosol fire suppression apparatus, wherein the activation device includes a safety pull ring 17, a button 13, a safety sliding piece 14, and piezoelectric ceramics 15.

Compared with the prior art, the present invention has the following advantages: 1. the outer cylinder is provided with three or more inner cylinder components, so as to achieve a large ejecting area, a high fire suppression efficiency, and safety in use; 2. the members of the inner cylinder component are assembled together as one component, so as to achieve a convenient assembly and a high production efficiency.

### BRIEF DESCRIPTION OF THE DRAWINGS

FIG. 1 is a diagram showing the appearance of the apparatus of the present invention.

FIG. 2 is a structural diagram of the inner cylinder component of the present invention.

FIG. 3 is a structural diagram of the activation device of the present invention.

1—spring, 2—heat insulation sleeve, 3—ignition head, 4—granular chemical coolant, 5—gasket, 6—cellular chemical coolant, 7—trumpet—like jet pipe, 8—inner cylinder, 9—inner cylinder front cover, 10—sealing ring, 11—chemical agent, 12—jet orifice, 13—button, 14—safety sliding piece, 15—piezoelectric ceramics, 16—handle upper enclosure, 17—safety pull ring, 18—handle lower enclosure, 19—outer cylinder

### MODES FOR CARRYING OUT THE INVENTION

Hereinafter, the embodiments of the present invention are described in detail with reference to the drawings.

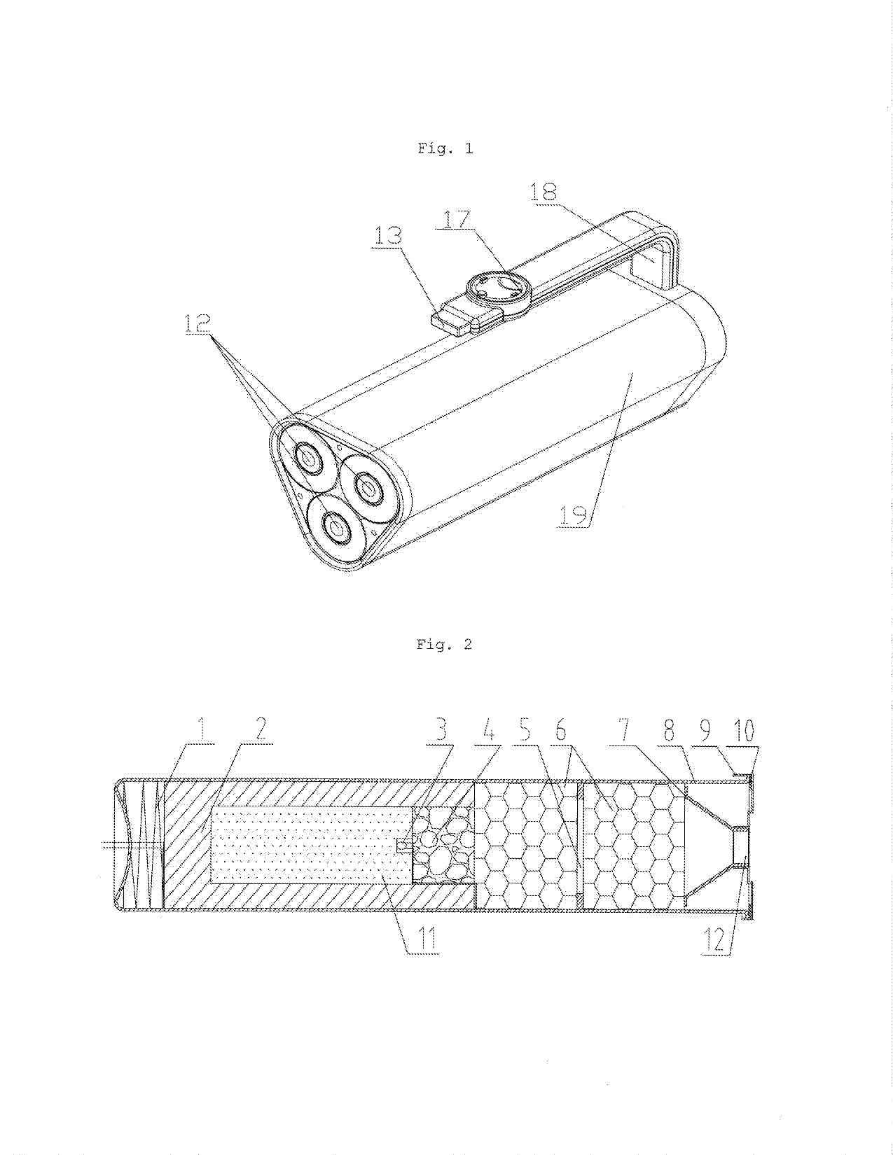

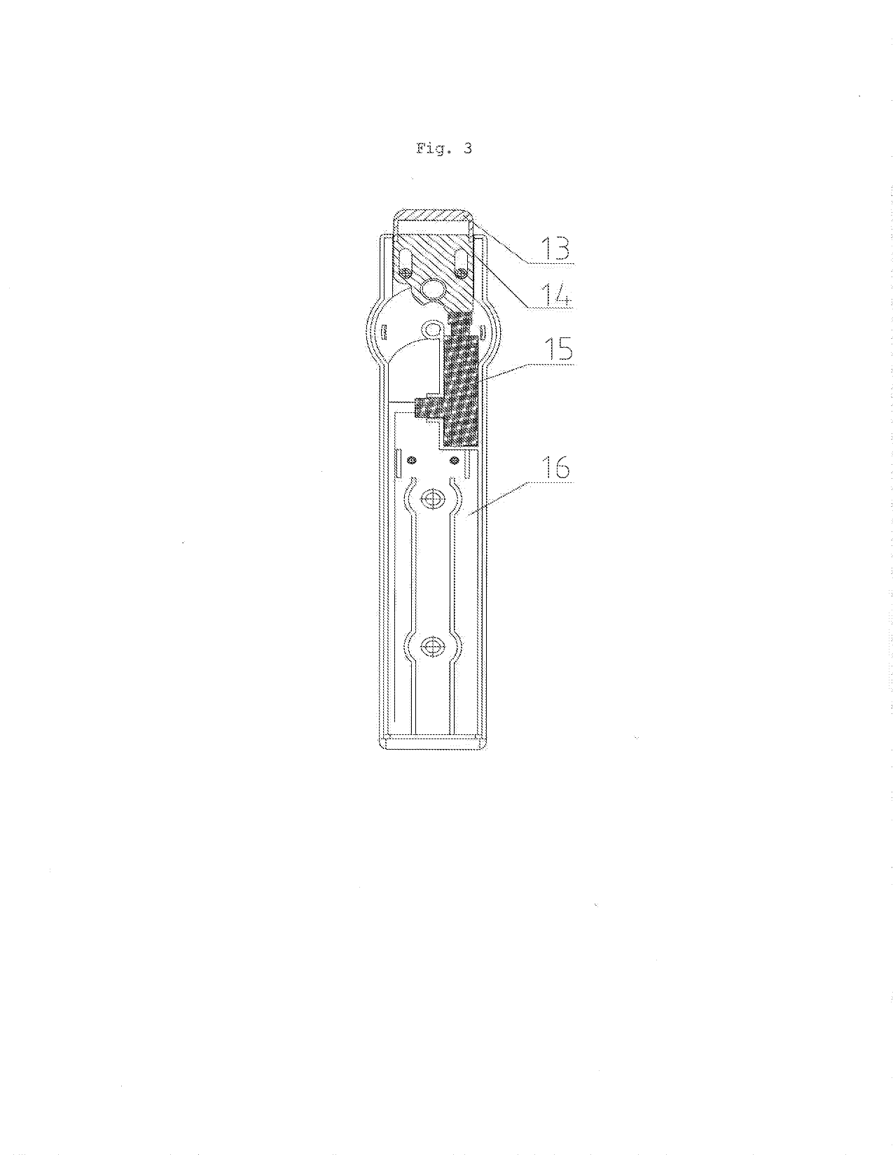

As shown in FIGS. 1 and 3, the assembling method of the hand-held aerosol fire suppression apparatus of the present invention comprises the following steps: sequentially assembling a shock absorbing spring 1, a heat insulation sleeve 2, a chemical agent 11, an ignition head 3, a granular chemical coolant 4, a cellular chemical coolant 6, a trumpet-like jet pipe 7, a sealing ring 10 and an inner cylinder front cover 9, and sealing the inner cylinder front cover 9 to form an inner cylinder component; inserting the inner cylinder component into the outer cylinder 19, wherein a silicon rubber is filled between the inner cylinder component and the outer cylinder 19 and is cured; assembling a handle component, which includes a handle upper enclosure 16 and a handle lower enclosure 18, and the inner structure of which is sequentially composed of a button 13, a safety sliding piece 14 and piezoelectric ceramics 15; inserting a safety pull ring 17; connecting electrical wire and fixing with screws to form a fire extinguisher product.

When this apparatus is in use, the safety pull ring 17 is pulled out, the button 13 is pressed, the chemical 11 is ignited, and the generated hot aerosol is cooled by the granular chemical coolant 4 and the cellular chemical coolant 6 and is then accelerated by the trumpet-like jet pipe 7 and is finally ejected from the jet orifice 12 to extinguish the fire.

The embodiments are described above, but any modifications in the form and details will not affect the substance and the protection scope of this apparatus.

1. A hand-held aerosol fire suppression apparatus, comprising:
an outer cylinder;
inner cylinder components; and
an activation device,
wherein each outer cylinder is provided with at least three inner cylinder components.

2. The hand-held aerosol fire suppression apparatus according to claim 1, wherein the inner cylinder components are directly fixed to the outer cylinder.

3. The hand-held aerosol fire suppression apparatus according to claim 1, wherein the inner cylinder component comprises a spring, a heat insulation sleeve, a medical agent, an ignition head, a granular chemical coolant, a cellular chemical coolant, a trumpet-like jet pipe, a sealing ring, and an inner cylinder front cover.

4. The hand-held aerosol fire suppression apparatus according to claim 3, wherein the activation device comprises a safety pull ring, a button, a safety sliding piece, and piezoelectric ceramics.
